(19) United States
(12) Patent Application Publication
(10) Pub. No.: US 2022/0349791 A1
(43) Pub. Date: Nov. 3, 2022

(54) PROPORTIONAL CALIBRATION METHOD FOR BARKHAUSEN MEASUREMENT METHOD

(71) Applicants: Schreiber JUERGEN, Dresden (DE); SMART CONTROL SENSING, Daejeon (KR)

(72) Inventors: Schreiber JUERGEN, Dresden (DE); Woo Sang LEE, Sejong (KR); Seung Ju LEE, Daejeon (KR); Young Hyun NAM, Daejeon (KR)

(21) Appl. No.: 17/761,089

(22) PCT Filed: Sep. 14, 2020
(86) PCT No.: PCT/KR2020/012359

§ 371 Date: Mar. 16, 2022

(30) Foreign Application Priority Data
Sep. 20, 2019 (KR) 10-2019-0115802
Sep. 20, 2019 (KR) 10-2020-0007117
Sep. 20, 2019 (KR) 10-2020-0007120

(51) Int. Cl. G01N 3/08

(52) U.S. Cl. CPC G01N 3/08; G01N 2203/0016; G01N 2203/0098

(57) ABSTRACT

The present invention relates to a device for measuring residual stress and hardness. Residual stress remaining in a metallic material due to deformation, thermal stress, or the like is a cause of various problems including degradation of mechanical properties such as fatigue strength and fracture properties and difficulty in post-processing. It is very difficult to derive a calibration curve when measuring stress by an existing non-destructive Barkhausen noise measurement method. When cross points of Barkhausen noise measurements for three or more stresses are not at one position, calibrated curves can be easily found by scaling the Barkhausen noise measurements by using calibration equations of the present invention to collect the cross points at a unique position, thereby providing a practical method of easily measuring stress of a metal by a Barkhausen noise measurement method. Therefore, according to the present invention, it is found that the internal microstructure and surface residual stress of a metal cause crossing points not to be at a unique position in a conventional Barkhausen noise measurement experiment. In addition, basic physical properties and surface residual stress of a metallic material may be measured using the above-mentioned physical feature.

### TECHNICAL FIELD

The present invention relates to a technique for measuring the surface residual stress and hardness of a ferromagnetic metal by a Barkhausen noise measurement method.

### BACKGROUND ART

The present invention relates to a residual stress and hardness measuring device, and residual stress remaining in metals because of deformation or thermal stress of the metals deteriorates the mechanical properties of the metals such as fatigue strength and fracture properties, and results in various problems such as difficulty in post-processing.

The present invention relates to a method of using a Barkhausen noise measurement method among various residual stress measurement methods. In the method, noise, which occurs during magnetization of a ferromagnetic metallic material because magnetic domain walls stop moving due to non-uniform components and internal defects included in the ferromagnetic metal, is called Barkhausen noise.

The magnitude of Barkhausen noise generated as described above is related to the residual stress and hardness of the metallic material.

Prior to the present invention, techniques for handling cast iron parts of vehicles or engines have been disclosed as prior techniques related to Barkhausen noise measurement. There is a prior technique including a process of measuring Barkhausen noise parameters on the surface of a cast iron part, a process of calculating the hardness of the cast iron part using the measured Barkhausen noise parameters, and a process of determining whether the calculated hardness is within an allowable range.

There is another prior technique relating to a device for more reliably measuring physical properties of a metallic material in a high-pressure environment by using Barkhausen noise. This technique uses the Barkhausen effect occurring when a magnetic field is applied to a metallic material to which tensile stress greater than yield strength and thus capable of causing plastic deformation is applied in a high-pressure environment. To this end, the device for measuring physical properties of a metallic material includes: a pressure adjusting unit which is configured to create a high-pressure environment inside a case; a pressure measuring unit and a temperature measuring unit which are configured to measure the internal pressure and temperature of the case; a jig which is configured to apply tensile stress to a specimen put in the case; a Barkhausen noise sensor which is configured to detect magnetic properties of the specimen; a Barkhausen noise measuring unit which is configured to analyze physical properties of the specimen based on a signal detected using the Barkhausen noise sensor; and a control unit which is configured to control the operation of the pressure adjusting unit based on information received from the pressure measuring unit and the temperature measuring unit.

### DISCLOSURE

### Technical Problem

The present invention provides a method of accurately measuring residual stress and hardness without complex multiple regression analysis, thereby solving problems which are not solved with Barkhausen noise measurement devices of the related art.

### Technical Solution

The present invention provides the following method to solve problems described above.

When crossing points of Barkhausen noise measurements for three or more stresses are not at one position,

there is provided a proportional calibration method for a Barkhausen measurement method, the proportional calibration method being characterized in that the Barkhausen noise measurements are scaled using equations below such that the Barkhausen noise measurements have a unique crossing point.

xBNA(yHₘ*)_{measered}=BNA_{ref}(H*) Equation 2

Σn(xBNA(Hn_{by stress})−BNAref(Hₙ))²≈0 Equation 3

(H* refers to a crossing point, Hm* refers to a crossing point of measurements, x and y refer to scaling values, ref refers to one selected from measurements which is usually a zero-stress curve, “measured” refers to measured curves except for a curve used as a ref, and n refers to the number of measurement points for each stress.)

Furthermore, the proportional calibration method for a Barkhausen measurement method is characterized in that in the Barkhausen noise measurements, an X axis refers to a magnetic field, and a Y axis refers to Barkhausen noise.

### Advantageous Effects

In research for the present invention, it was found why crossing points are not at one position in conventional Barkhausen noise measurement experiments. This is because of the internal microstructure of a metal and residual stress remaining on the surface of the metal.

That is, because of undesired residual stress remaining in a metal to be measured, crossing points are not at one position in conventional Barkhausen noise measurement experiments.

Thus, a metal in which no stress is present is necessary for Barkhausen noise measurement experiments, and it is almost impossible to set a starting point without such a metal.

However, according to the present invention, Barkhausen noise measurement curves, which are obtained through an experiment as described above and of which crossing points are not at one position, are scaled such that the crossing points are at one position, thereby finding basic physical properties and surface residual stress of a metallic material.

### BRIEF DESCRIPTION OF DRAWINGS

FIG. 1 shows hysteresis of a metal which has different stresses and put in a magnetic field for measurement according to the present invention. B refers to the magnetic flux density of the metal, and H refers to the magnitude of the magnetic field applied to the metal.

FIG. 2 shows a basic measurement configuration by a Barkhausen noise measurement method according to the present invention.

The upper left graph shows a magnetic field waveform, and the graph just below shows a magnetic field and Barkhausen noise. Here, the next lower graph shows only the Barkhausen noise by filtering the magnetic field. The lower left graph shows a measured tangential field strength. The graph on the right side shows changes inside a magnetic material as the magnetic field increases.

FIG. 3 shows a Barkhausen noise signal with respect to time according to the present invention. The black color shows the Barkhausen noise signal, the sine curve at the bottom shows a magnetic field signal, and the white signal line drawn inside the black noise signal shows smoothed Barkhausen noise.

FIG. 4 is a graph illustrating various microstructures having various Vickers hardness values HV, in which the X-axis refers to residual stress calculated using Barkhausen noise according to the present invention, the Y-axis refers to Mmax and Hcm.

FIG. 5 shows results of measurement of Barkhausen noise when a metallic material of ST37 type having no residual stress was glued and tensioned. There is a unique crossing point in FIG. 5.

FIG. 6 is a graph showing B-H signal loops for the density of 0.3 to 1.7 teslas according to the present invention.

FIG. 7 is a conceptual view illustrating a bending experiment according to the present invention. F refers to an upward or downward bending force acting on the end of a metal beam. X refers to the distance from the end of the metal beam. Y refers to deflection. A measuring unit for measuring Barkhausen noise is indicated with a green arrow, and the location thereof is xs=(I−IS). In an actual measurement of the present invention, I=167 mm, b=20 mm, h=1.9 mm, and xs=75 mm, and elastic modulus E=210 GPa, S235 yield strength is 185 to 355 MPa.

FIG. 8 is an actual photograph showing a measurement of Barkhausen noise in a bending experiment of the present invention according to the conceptual view of FIG. 7. An upward or downward bending experiment was performed using a vise.

FIG. 9 is a graph on the screen of iSCAN software of an experimental device of the present invention, the graph showing the magnitude of a Barkhausen noise signal with respect to the strength of a magnetic field. The graph shows Barkhausen noise measured using an INTROSCAN device connected to a computer through a USB cable.

FIG. 10 shows results of an upward or downward bending experiment performed using the experimental device shown in FIG. 9 and the experimental device shown in FIG. 8. FIG. 10 shows rising curves for stresses which are calculated from the experimental results by Equation 7. The graph on the left shows results of a tensile stress measurement test, and the right graph shows results of a compressive stress measurement test. In both the graphs, it can be seen that all the crossing points are not at the same position.

FIG. 11 shows rising curves which cross each other at one crossing point, the rising curves being obtained by scaling compressive stress curves by using Equations 2 and 3 according to the present invention.

Crossing point H*=137 [a.u.], H_{WP}=60 [a.u.], Pσ=xBNA(y·H_{WP})

### BEST MODE

### Mode for Invention

Operational effects of the present invention will be described with reference to the drawings as follows.

First, a Barkhausen noise (BHN) measurement method of the present invention will be described, and then scaled Barkhausen noise will be described, which is obtained according to an improved method of the present invention using a modified measurement graph by two-dimensionally scaling measured Barkhausen noise independently in each axis.

Residual stress remaining in a metallic material may be detected by a destructive method or a non-destructive method. Among the methods, a Barkhausen noise measurement method using magnetic force is very important non-destructive measurement method in which the surface residual stress of a ferromagnetic material is measured.

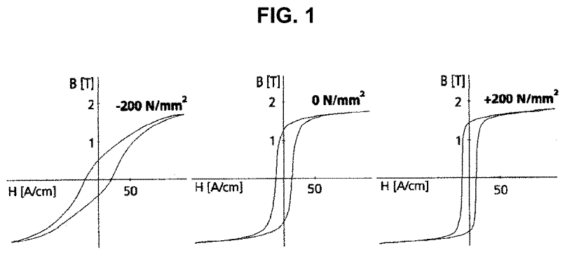

As shown in FIG. 1, the magnetism and mechanical stress of a metal are related to the magnetic hysteresis loop of the metal. FIG. 1 shows that the magnetic hysteresis loop of a ferromagnetic metal varies with the magnitude of residual stress remaining in the ferromagnetic metal. FIG. 1 shows that the hysteresis loop straightens and becomes smaller with respect to tensile stress, but becomes flatter with an increased coercive force. However, this method is not practical because it is very difficult to measure the hysteresis.

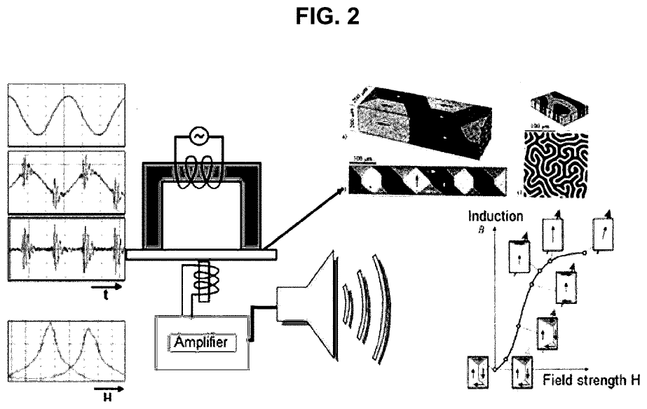

FIG. 2 shows a Barkhausen noise (BN) measurement method as a more practical measurement method. In a ferromagnetic material, two different structures are combined with each other. One is a crystal structure, and the other is a magnetic structure composed of domains.

A Barkhausen effect refers to a method of utilizing interaction between the crystal structure and the magnetic structure. Each domain is an atomic lattice region in which the magnetic moments of atoms have the same orientation, and the orientations of domains constituting a material may be different from each other.

Therefore, between two adjacent domains, there is a region in which the direction of magnetic vectors smoothly changes oppositely from the direction of the first domain to the direction of the second domain. This region is called a Bloch wall or domain wall because the region separates two domains from each other. The position of a domain wall may vary according to the configuration of magnetic vectors.

FIG. 2 shows: a configuration for measuring Barkhausen noise; and a domain structure, which changes inside a metallic object according to the strength of a magnetic field, together with an electrical signal.

The graphs on the left side show, from the top, a magnetic field strength, a mixed signal of a magnetic field and Barkhausen noise, a Barkhausen signal, and a flattened Barkhausen noise. The graph on the right side shows that the domain structure changes as the magnetic field strength increases.

The graph on the right side in FIG. 2 shows that when there is no external magnetic field, domain walls do not change and remain in an unaligned and stable state in which the entire magnetic field energy is minimal. However, when an external magnetic field is applied to a metal, the magnetic vectors of the metal start to align.

The alignment direction is vertical for easy magnetization. This change by the magnetic field causes the domain walls to move. The movement strength of the domain walls is related to residual stress remaining in the metal. This is because residual stress impedes or stimulates the reconstruction of magnetic vectors.

The reconstruction of a magnetic field occurs from a change in magnetic flux. The change in magnetic flux is caused by an induced voltage pulse. A signal is measured using a sensing coil made of a conductive wire. The degree of movement of a domain wall varies in proportion to the magnitude of the induced voltage pulse.

In most cases, domain walls move individually. That is, all domains do not move at the same time. The movements of different magnetic domain walls create numerous voltage pulses, and the voltage pulses generate a Barkhausen signal called Barkhausen noise.

That is, the domain walls of a metallic object are moved by an external magnetic field applied to the metallic object, and the degree of the movements of the domain walls is proportional to the strength of the magnetic field. While the domain walls of the metallic object are individually moved by the magnetic field applied to the metallic object, voltage pulses, called Barkhausen noise, are generated.

In addition, since the movements of the domain walls are related to residual stress of the metallic object, the residual stress of the metal can be measured by analyzing the Barkhausen noise.

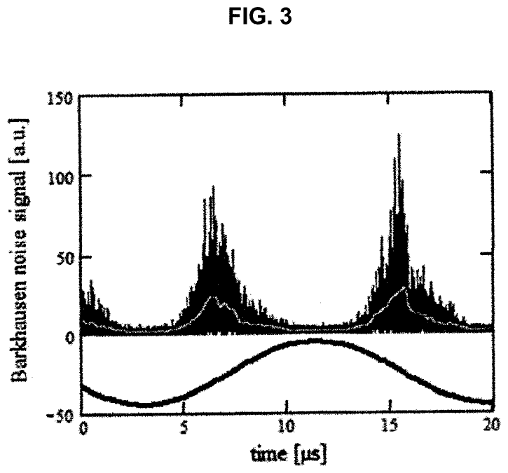

FIG. 3 shows a Barkhausen noise signal with respect to time. The sine wave at the bottom shows the waveform and magnitude of a magnetic field applied at 60 Hz. The white line inside black noise is a flattened BHN signal.

According to the present invention, the surface measurement depth of a metallic material for measuring Barkhausen noise is determined by the properties of the material to be measured, such as the permeability and conductivity of the metal. In a Barkhausen noise measurement experiment with a 20-kHz magnetic field signal, it was found that a signal was measured at a depth of 1 mm from a metal surface.

Standard Barkhausen noise is obtained as a signal as shown in FIG. 3. Usually, one of a maximum peak value M_{MAX}, a peak position H_{CM}, the width of an envelope DM, the RMS (Root Mean Square) value of a BHN voltage, and the integral of bursts is used as a measurement value of BHN.

In a practical stress measurement, residual stress is calculated by comparing a Barkhausen noise measurement value with a stress response curve of a material (having the same composition and microstructure) similar to a measured material.

In the simplest case, calibration curves are determined under uniaxial loading with the direction of magnetization parallel and transverse to the direction of loading.

It is difficult to calculate the magnitude of residual stress remaining in a metallic material using a calibration curve because of the diversity of the microstructure of the metallic material to be measured.

Calibration methods for stress measurement or the like may be improved using a magnetic field magnitude HCM. In this method, the coercive force of a metal to be measured is measured using a Hall sensor, which is a magnetic force line measuring sensor, and is corrected using a B-H hysteresis curve. This method is more sensitive to microstructures than to stress states. Therefore, an appropriate calibration curve may be selected among calibration curves for various microstructural states of a metal to be measured.

However, when the influences of microstructural states and residual stress are combined with each other, it is complex because the use of at least two independent ND parameters are required to avoid ambiguous results.

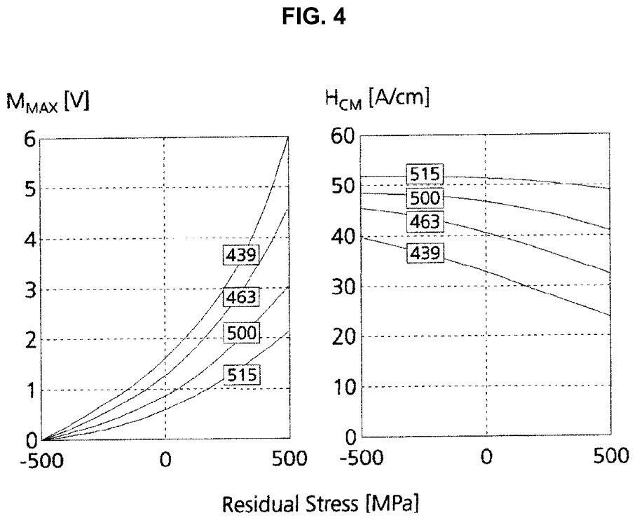

A method of using a Barkhausen signal for measuring residual stress is provided in FIG. 4. Parameters M_{MAX} and H_{CM} are both measured with a setup technique. M_{MAX}, referring to the maximum value of a rectified Barkhausen signal, shows a non-linear dependency on stress for an annealed state (stress in an annealed state) and a linear reaction for a hard martensite state (metastable state occurring when a carbon-iron alloy is quenched). This behaviour is always observed in ferromagnetic polycrystalline materials with positive magnetostriction.

Coercivity H_{CM} shows the same stress dependency as macroscopic coercivity value H_{C} evaluated from hysteresis measurements. That is, coercivity H_{CM} shows a more or less linear behaviour for a hard material and a non-linear reaction for a soft material state. Both information can be used to determine a stress state and/or a hardness value.

In conventional micromagnetic methods, it is required to calculate calibration values using micromagnetic parameters and a large number of samples defining stress states for all possible relevant deformation structures. From a practical point of view, it is very difficult to obtain calibration curves by the conventional methods because such calibration samples are not available or are not practically available.

In addition, the calibration of micromagnetic parameters can also be performed using x-ray or neutron diffraction methods, especially when the calibration must be performed on a component itself. However, this is only a way for validation and not for practical industrial usage.

The scaled Barkhausen noise amplitude (SBNA) measurement method of the present invention is the only practical method applicable to industrial sites.

According to the method of the present invention, the residual stress and microstructure of a metallic material is found from a Barkhausen noise signal not by excessive calibration or multiple regression analysis, but by physical reasons.

The present invention provides a method for measuring the residual stress remaining on a metal surface in the process of explaining the physical relationship between a metallic material and a Barkhausen noise signal without excessive calibration or multiple regression analysis.

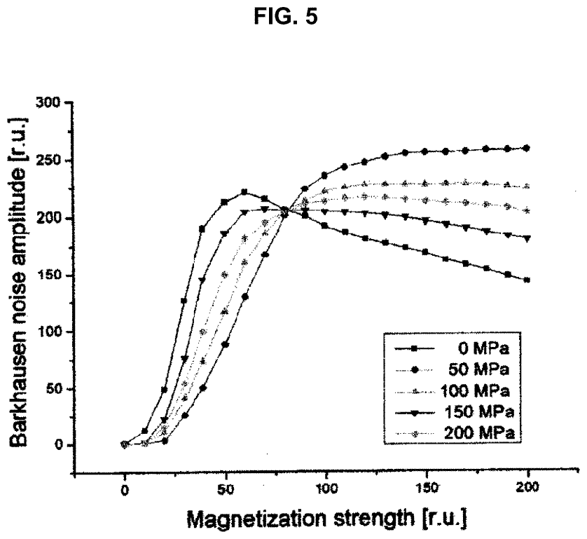

Experimental results showing in FIG. 5 provide a first hint for solving residual stress and a Barkhausen noise signal. FIG. 5 is a graph showing results of a measurement in which the amplitude of a Barkhausen noise signal and the strength of a magnetic field were measured while increasing a tensile force (for a tensile experiment, a steel bar was glued with an adhesive without stress). The graph shows that Barkhausen noise signal curves with respect to a magnetic field have one crossing point. This is a very ideal case, and in most cases, Barkhausen noise signal versus magnetization strength curves do not cross each other at one point unlike the case shown in FIG. 5.

The present invention provides a physical reason explaining why crossing characteristics shown in FIG. 5 do not appear in general Barkhausen noise measurements. The present invention relates to a method of accurately separating, based on the physical reason, the effect of stress and the effect of a microstructure from each other, which are included in an experimentally measured Barkhausen noise signal.

That is, in experiments, Barkhausen noise curves for different stresses did not have the same crossing point because the microstructure of a measured metal was deformed and the surface stress of the metal was not zero.

According to the present invention, calibration curves which cross each other at one crossing point are obtained by a scaling method from Barkhausen noise versus magnetization strength curves which do not cross each other at one crossing point because of the microstructure and residual surface stress of a measured metal.

In addition, the effect of stress and the effect of a microstructure can be accurately separated from the Barkhausen noise versus magnetization strength curves by using the calibration curves.

A method of drawing a scaled Barkhausen noise graph of the present invention from Barkhausen noise signals measured in a normal manner, that is, from Barkhausen noise versus magnetization strength curves, will now be described.

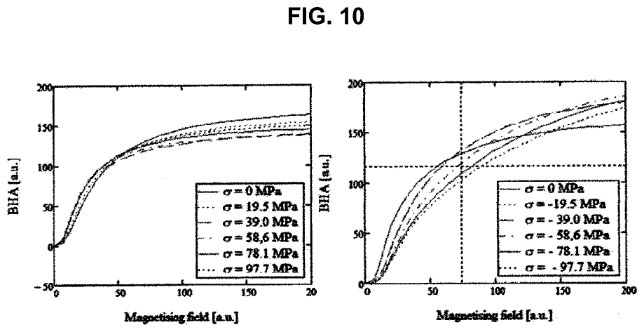

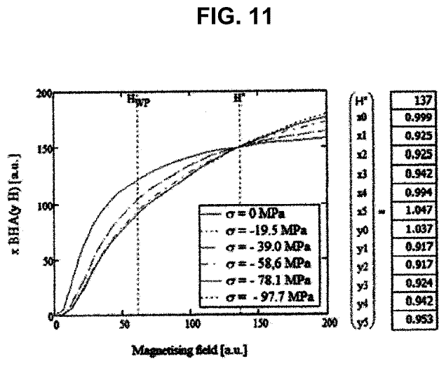

That is, a method of scaling the graph on the right side in FIG. 10 such that the graph has one crossing point as shown in FIG. 11 will now be described.

a. The Barkhausen noise amplitude (BNA) increases together with the stress value σ when the magnetizing field is less than the crossing field value H* (magnetic field strength at the crossing point), but the BNA decreases as the stress value σ increases when the magnetic field is greater than H*.

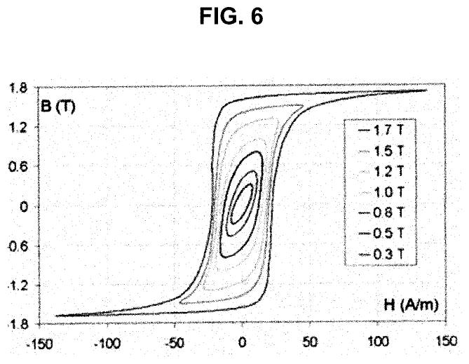

b. Referring to the hysteresis for varying the strength of magnetization (FIG. 6), the larger the magnetic field the smaller the contribution of BHA jumps to an integrated measurement signal averaged over the entire field area. Therefore, the averaged BNA becomes smaller for a sufficiently large H.

c. The coercive field H_{CM} is a function of stress and decreases as stress increases. Thus, for a sufficiently large H, the Barkhausen noise signal decreases. In addition, the crossing point H* depends on the coercive field.

d. The crossing point H* is a key feature of the present invention. BNA at the crossing point H* of a metallic point is only influenced by the microstructure of the metallic material.

The features described above explain the reason that a unique crossing point H* is not found for various loads in a bending experiment performed on a metallic material. That is, surface plasticity and variations in coercivity H_{CM}, which are caused by an increase in the surface stress of a metallic material used in an experiment, changes BNA at H=H* or the crossing point itself. That is, X-axis and/or Y-axis deformation occur.

Therefore, a BNA-H graph having one crossing point like that in FIG. 5 may be obtained by scaling BNA (Y axis) as well as a magnetic field to find a unique crossing point for all mechanical stresses and microstructures. Thus, Barkhausen noise versus magnetization strength curves needs to be scaled on both the X and Y axes. Finding the reason that Barkhausen noise versus magnetization strength curves do not cross at the same point and accordingly vary in the X and Y axes will constitute a great invention.

Equation 1 expresses scaling of BNA(H) of the present invention by applying a magnitude scaling parameter x and a magnetic field scaling parameter y to an existing BNA(H).

BNA(H)→xBNA(yH) Equation 1

For harder materials, the value of the parameter x is greater than 1.

In order to determine the parameters x and y, Equations 2 and 3 below are used.

xBNA(yHₘ*)measered=BNAref(H*) Equation 2

Σn(xBNA(Hn_{by stress})−BNAref(Hn))²≈0 Equation 3

=Ev (Evaluation value)→Minimum

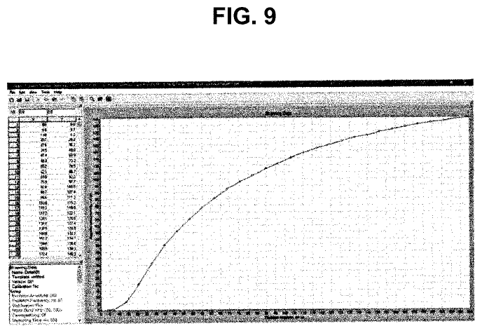

In the equations above, n refers to an index for all measurement points in a measurement as shown in FIG. 9. BNAref(H*) refers to a reference value set by selecting one of measured BNA(H) values.

Here, H* refers to a crossing point, and an initial crossing point is arbitrarily set.

Therefore, a measured BNA(H) curve for stress σ=0 is generally used as BNAref(H).

Among graphs such as the graph shown in FIG. 9 which are obtained through a bending experiment performed on a metallic material for a plurality of different loads, one is selected as a BNAref(H) graph, and a point on the selected BNAref(H) is determined as a crossing point (H*, BNAref(H*)) for the calculation of Equation 2.

With Equation 3, graphs of values measured for different stresses can be scaled such that deviations are as small as possible. The process of finding x and y while minimizing the value of Equation 3 is a scaled Barkhausen noise measurement method of the present invention.

Equation 3 is the same as the variance calculation equation, and Equation 3 is used to select scaling values x and y such that the difference between the graph selected as a reference and all the other graphs is not excessively large.

For the Barkhausen noise scaling of the present invention, an arbitrarily selected point is used as an initial value of H*. One of possible crossing points is arbitrarily set such that all crossing points may meet each other at one point after scaling as shown in FIG. 5. In generally, one of crossing points of a zero-stress a curve is used.

First, Equation 2 is used as follows: a curve for a stress of 0 Mpa is selected from the graph on the right side in FIG. 10 as a reference curve on the right side of Equation 2, and then x and y on the left side of Equation 2 are calculated sequentially for stresses of −19.5 MPa, −39.0 MPa, −58.6 MPa, −78.1 MPa, and −97.7 MPa.

Using Equation 3 for calculating the difference between scaled xBNA (Hn_{by stress}) and reference curve BNAref(Hn), the deviation value Ev is calculated for each measured stress value. This process is repeated to obtain an optimal value of H* and scaling values (X, Y) when the calculated deviation value Ev is minimal. Results obtained in this way are shown in the graph of FIG. 11 and the matrix (X, Y) on the right side of the graph of FIG. 11.

These calculations may be performed with a general mathematical calculation program.

While correcting (x, y) obtained with Equation 2, an optimal scaled Barkhausen noise signal SBNA-H having a unique crossing point as in the graph of FIG. 11 is obtained from the graph on the right of FIG. 10.

In addition, referring to the matrix on the right of FIG. 11, X0 and Y0 are not 1, and surface stress remaining in a metallic material to which zero stress is applied may be calculated from the values X0 an Y0.

### Example 1

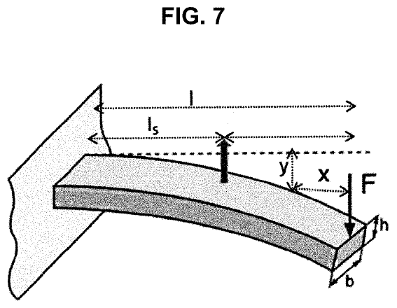

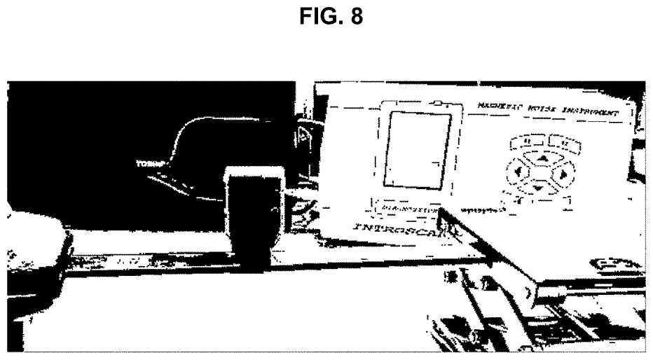

Symbols X and Y used in Example 1 up to Table 2 refer to positions for measuring bending stress as shown in FIGS. 7 and 8, and are different from X and Y for scaling which are used in other parts of the present application. Here, X refers to the distance from an end to the position of a sensor in a bending experiment, and Y refers to a vertical displacement from the position of the sensor for calculating stress. X and Y are used with these meanings only in Equations 4 to 7 and Tables 1 and 2.

First, the theory of a bending experiment will be described.

In contrast to a tensile test experiment, the theoretical stress state on the surface of a sample is exactly applied when a metal bar clamped on one side is bent. In the experiment shown in FIG. 7, the exact stress at the position Xs of a Barkhausen noise sensor is given by Equation 4.

$$σ ( y ) := \frac{( 3 \cdot E \cdot y \cdot mm \cdot {x}_{x} \cdot h )}{{l}^{3} \cdot [ 2 - 3 \cdot \frac{x}{l} + {( \frac{x}{l} )}^{3} ]} \qquad Equation 4$$

In the experiment of the present invention, strain y, not force F, is a variable, and variations in stress with respect to strain y are calculated using Equation 4 as shown in Table 1 below.

TABLE 1

| Y | −10 | −8 | −6 | −4 | −2 | 0 | 2 | 4 | 6 | 8 | 10 |
|---|---|---|---|---|---|---|---|---|---|---|---|
| Stress | −121.957 | −97.565 | −73.174 | −48.783 | −24.391 | 0 | 24.391 | 48.783 | 73.174 | 97.565 | 121.957 |

Considering that a BHN probe detects signals within a frequency range of 200 to 1000 kHz, experimental data should be compared with stress values averaged for a corresponding depth of a sample. In the bending experiment, the stress along the depth z varies linearly.

$$σ ( z , y ) = σ ( y ) \cdot ( 1 - 2 \cdot \frac{z}{h} ) \qquad Equation 5$$

Considering that the BHN probe detects signals within a frequency range of 200 to 1000 kHz, the penetration depth of a magnetic signal detected by the BHN probe can be expressed by the following relational expression.

$${d}_{s} ( f ) = \sqrt{\frac{{f}_{20}}{f \cdot kHz}} \cdot 1 \cdot mm \qquad Equation 6$$

The penetration depth of BNA using a 20 kHz magnetic field frequency was experimentally determined as ds(20 kHz)=1 mm. Equation 6 was derived based on this experiment.

The average penetration depth ds,av=0.195 mm was calculated within the frequency range of 200 to 1000 kHz. Here, the average stress corresponding to a BHN measurement is expressed as Equation 7 by the integral using Equations 5 and 6.

$${σ}_{av} ( y ) = {\int }_{{f}_{u}}^{{f}_{0}} \frac{1}{No ( f ) \cdot ( {f}_{0} - {f}_{u} )} \cdot {\int }_{0}^{h} σ ( z , y ) \cdot exp ( \frac{- z}{{d}_{s} ( f )} ) dzdf \qquad Equation 7$$

In Equation 7, No(f) refers to a normalization coefficient for the second integral. That is, this is a stress correction equation for the penetration depth. Average bending stress calculated using Equation 7 in Table 1 is shown in Table 2 below.

TABLE 2

| Y | −10 | −8 | −6 | −4 | −2 | 0 | 2 | 4 | 6 | 8 | 10 |
|---|---|---|---|---|---|---|---|---|---|---|---|
| Stress | −97.681 | −78.145 | −58.609 | −39.073 | −19.536 | 0 | 19.536 | 39.073 | 58.609 | 78.145 | 97.681 |

### Example 2

Scaling is performed by obtaining actual experiment data and using the actual experimental data.

An experimental device is configured as shown in FIG. 8. In the experiment configured in this way, data is measured using iScan by INTROSCAN as shown in FIG. 9. FIG. 10 shows the experimental data for different deflections. The left side of FIG. 10 shows results of a tensile bending experiment, and the right side of FIG. 10 shows results of a compressive bending test. The minus symbol (−) on all data indicates compression. Referring to the tensile experimental results shown in FIG. 10, almost one crossing point was observed in data measured while increasing the tensile stress by increasing the strain. However, as the stress increased, the crossing point moved more upwards. This is because of the change of the microstructure and coercive field at the sample surface area. In FIG. 10, the curves for compressive stresses don't show a unique crossing behaviour. Three magnetic field characteristics are used for the estimation of stress, hardness, and coercive force.

The graph shown in FIG. 11 is obtained by scaling the experimental results shown in FIG. 10 using Equations 2 and 3. When a crossing point H* is obtained in this way, H_{wp} is set below the crossing point H* at a point at which curves are distinguishably separated from each other.

A means for exhibiting the effects described above will now be described.

When cross points of Barkhausen noise measurements for three or more stresses are not at a unique position,

a proportional calibration method for a Barkhausen measurement method is provided, which is characterized in that Barkhausen noise measurements are scaled using the following equations such that the Barkhausen noise measurements may have a unique crossing point.

xBNA(yHₘ*)_{measered}=BNA_{ref}(H*) Equation 2

Σn(xBNA(Hn_{by stress})−BNAref(Hₙ))²≈0 Equation 3

(H* refers to a crossing point, Hm* refers to a crossing point of measurements, x and y refer to scaling values, ref refers to one selected from measurements which is usually a zero-stress curve, “measured” refers to measured curves except for a curve used as a ref, and n refers to the number of measurement points for each stress)

When cross points of Barkhausen noise measurements for three or more stresses are not at a unique position, a proportional calibration method for a Barkhausen measurement method is provided, which is characterized in that Barkhausen noise measurements are scaled using Equations 2 and 3 such that the Barkhausen noise measurements may have a unique crossing point, and

the penetration depth of a magnetic signal detected by a BHN probe for measuring Barkhausen noise is calculated using Equation 6 below.

xBNA(yHₘ*)_{measered}=BNA_{ref}(H*) Equation 2

Σn(xBNA(Hn_{by stress})−BNAref(Hn))²≈0 Equation 3

$${d}_{s} ( f ) = \sqrt{\frac{{f}_{20}}{f \cdot kHz}} \cdot 1 \cdot mm \qquad Equation 6$$

(H* refers to a crossing point, Hm* refers to a crossing point of measurements, x and y refer to scaling values, ref refers to one selected from measurements which is usually a zero-stress curve, “measured” refers to measured curves except for a curve used as a ref, and n refers to the number of measurement points for each stress, and a penetration depth ds(f) with respect to a measurement frequency (f) is calculated relative to a penetration depth of 1 mm at a frequency of 20 kHz by using Equation 6 above.)

When cross points of Barkhausen noise measurements for three or more stresses are not at a unique position, a proportional calibration method for a Barkhausen measurement method is provided, which is characterized in that Barkhausen noise measurements are scaled using Equations 2 and 3 such that the Barkhausen noise measurements may have a unique crossing point.

The proportional calibration method is also characterized in that the penetration depth of a magnetic signal detected by a BHN probe for measuring Barkhausen noise is calculated using Equation 6, and is compared with averaged stress values varying linearly with respect to the depth.

xBNA(yHₘ*)_{measered}=BNA_{ref}(H*) Equation 2

Σn(xBNA(Hn_{by stress})−BNAref(Hₙ))²≈0 Equation 3

$${d}_{s} ( f ) = \sqrt{\frac{{f}_{20}}{f \cdot kHz}} \cdot 1 \cdot mm \qquad Equation ( 6 )$$

(H* refers to a crossing point, Hm* refers to a crossing point of measurements, x and y refer to scaling values, ref refers to one selected from measurements which is usually a zero-stress curve, “measured” refers to measured curves except for a curve used as a ref, and n refers to the number of measurement points for each stress, and a penetration depth ds(f) with respect to a measurement frequency (f) is calculated relative to a penetration depth of 1 mm at a frequency of 20 kHz by using Equation 6 above.)

Furthermore, the proportional calibration method is characterized in that Barkhausen noise measurements are expressed with an X axis denoting a magnetic field and an Y axis denoting Barkhausen noise.

1. A proportional calibration method for a Barkhausen measurement method, the proportional calibration method being characterized in that when cross points of Barkhausen noise measurements for three or more stresses are not at one position, the Barkhausen noise measurements are scaled using equations below such that the Barkhausen noise measurements have a unique crossing point,
xBNA(yHₘ*)_{measered}=BNAref(H*) Equation 2
Σn(xBNA(Hn_{by stress})−BNAref(Hₙ))²≈0 Equation 3
where H* refers to a crossing point, Hm* refers to a crossing point of measurements, x and y refer to scaling values, ref refers to one selected from measurements which is usually a zero-stress curve, “measured” refers to measured curves except for a curve used as a ref, and n refers to the number of measurement points for each stress.

2. The proportional calibration method of claim 1, wherein in the Barkhausen noise measurements, an X axis refers to a magnetic field, and a Y axis refers to Barkhausen noise.

3. A proportional calibration method for a Barkhausen measurement method, the proportional calibration method being characterized in that when cross points of Barkhausen noise measurements for three or more stresses are not at one position, the Barkhausen noise measurements are scaled using Equations 2 and 3 below such that the Barkhausen noise measurements have a unique crossing point, and a penetration depth of a magnetic signal detected by a BHN probe for measuring Barkhausen noise is calculated using Equation 6 below,
xBNA(yHₘ*)_{measered}=BNAref(H*) Equation 2
Σn(xBNA(Hn_{by stress})−BNAref(Hₙ))²≈0 Equation 3
$${d}_{s} ( f ) = \sqrt{\frac{{f}_{20}}{f \cdot kHz}} \cdot 1 \cdot mm \qquad Equation 6$$
where H* refers to a crossing point, Hm* refers to a crossing point of measurements, x and y refer to scaling values, ref refers to one selected from measurements which is usually a zero-stress curve, “measured” refers to measured curves except for a curve used as a ref, n refers to the number of measurement points for each stress, and a penetration depth ds(f) with respect to a measurement frequency (f) is calculated relative to a penetration depth of 1 mm at a frequency of 20 kHz by using Equation 6 above.

4. The proportional calibration method of claim 3, wherein in the Barkhausen noise measurements, an X axis refers to a magnetic field, and a Y axis refers to Barkhausen noise.

5. A proportional calibration method for a Barkhausen measurement method, the proportional calibration method being characterized in that when cross points of Barkhausen noise measurements for three or more stresses are not at one position, the Barkhausen noise measurements are scaled using Equations 2 and 3 such that the Barkhausen noise measurements have a unique crossing point, and a penetration depth of a magnetic signal detected by a BHN probe for measuring Barkhausen noise is calculated using Equation 6 below and is compared with averaged stress values varying linearly with respect to the depth,
xBNA(yHₘ*)measered=BNAref(H*) Equation 2
Σn(xBNA(Hn_{by stress})−BNAref(Hₙ))²≈0 Equation 3
$${d}_{s} ( f ) = \sqrt{\frac{{f}_{20}}{f \cdot kHz}} \cdot 1 \cdot mm \qquad Equation ( 6 )$$
where H* refers to a crossing point, Hm* refers to a crossing point of measurements, x and y refer to scaling values, ref refers to one selected from measurements which is usually a zero-stress curve, “measured” refers to measured curves except for a curve used as a ref, n refers to the number of measurement points for each stress, and a penetration depth ds(f) with respect to a measurement frequency (f) is calculated relative to a penetration depth of 1 mm at a frequency of 20 kHz by using Equation 6 above.

6. The proportional calibration method of claim 5, wherein in the Barkhausen noise measurements, an X axis refers to a magnetic field, and a Y axis refers to Barkhausen noise.
